(19) United States
(12) Patent Application Publication
(10) Pub. No.: US 2015/0248739 A1
(43) Pub. Date: Sep. 3, 2015

(54) RECOMMENDATION SYSTEM OF EDUCATIONAL OPPORTUNITIES TO MEMBERS IN A SOCIAL NETWORK

(71) Applicant: LinkedIn Corporation, Mountain View, CA (US)

(72) Inventors: Robert M. Schulman, Menlo Park, CA (US); Ferris Jumah, San Francisco, CA (US); Matthew David Shoup, San Jose, CA (US); Alexander Nicolai Sorensen, Mountain View, CA (US)

(21) Appl. No.: 14/473,436

(22) Filed: Aug. 29, 2014

Related U.S. Application Data
(60) Provisional application No. 61/946,639, filed on Feb. 28, 2014.

(51) Int. Cl. G06Q 50/20; G09B 5/00

(52) U.S. Cl. CPC G06Q 50/2053; G09B 5/00

(57) ABSTRACT

A system and method are provided for recommending courses to members of a social networking system. The social networking system stores a plurality of member profiles associated with a plurality of members of the social networking system, wherein each member profile includes one or more skills associated with the member. Then, for a respective first member in the plurality of members, the social networking system determines one or more suggested skills for the respective first member based on the one or more skills stored in the respective first member's profile. The social networking system then selects one or more educational courses from a plurality of available educational courses based on the determined suggested skills and transmits the one or more selected educational courses to an electronic device associated with the member for display.

### TECHNICAL FIELD

The disclosed implementations relate generally to the field of social networks, and in particular to a system for recommending educational opportunities for members of a social networking system.

### BACKGROUND

The rise of the computer age has resulted in increased access to personalized services online. As the cost of electronics and networks drop, many services that were previously provided in person are now provided remotely over the Internet. For example, entertainment has increasingly shifted to the online space with companies such as Netflix and Amazon streaming TV shows and movies to members at home. Similarly, electronic mail (e-mail) has reduced the need for letters to be physically delivered. Instead, messages can be sent over networked systems almost instantly. Online social networking sites allow members to build and maintain personal and business relationships in a much more comprehensive and manageable matter.

A similar shift is beginning to take place in education. Increasingly, traditional educational institutions like universities, colleges, and schools are providing educational courses to members via the Internet. In addition, non-traditional education providers, such as the learning websites and massively open online course (MOOC) sites like Khan Academy and Coursera, provide education resources that are partially or entirely available for free online. Indeed, so much new educational content is now available online it may be difficult for members to determine the educational resources most useful to them.

### DESCRIPTION OF THE DRAWINGS

Some implementations are illustrated by way of example and not limitation in the figures of the accompanying drawings, in which:

FIG. 1 is a network diagram depicting a client-server system that includes various functional components of a social networking server system in accordance with some implementations.

FIG. 2 is a block diagram illustrating a client system in accordance with some implementations.

FIG. 3 is a block diagram illustrating a social networking server system in accordance with some implementations.

FIG. 4 depicts a block diagram of an exemplary data structure for the member profile database for storing member profiles in accordance with some implementations.

FIG. 5 depicts a block diagram of an exemplary skill set data structure for a plurality of members of the social networking server system in accordance with some implementations.

FIG. 6 is a member interface diagram illustrating an example of a member interface or web page having a personalized data feed (or content stream) via which a member of a social network service receives messages, status updates, and recommendations, according to some implementations.

FIG. 7 is a flow diagram illustrating a process for recommending educational courses to members of a social networking server system in accordance with some implementations.

FIG. 8 is a flow diagram illustrating a process for recommending educational courses to members of asocial networking server system in accordance with some implementations.

FIG. 9 is a flow diagram illustrating a process for recommending educational courses to members of a social networking server system in accordance with some implementations.

FIG. 10 is a flow diagram illustrating a process for recommending educational courses to members of a social networking server system in accordance with some implementations.

Like reference numerals refer to corresponding parts throughout the drawings.

### DETAILED DESCRIPTION

The present disclosure describes methods, systems and computer program products for leveraging data stored in member profiles and in a database of educational courses to recommend specific educational courses to specific members based on the skill information stored for those members. In the following description, for purposes of explanation, numerous specific details are set forth in order to provide a thorough understanding of the various aspects of different implementations. It will be evident, however, to one skilled in the art, that any particular implementation may be practiced without all of the specific details and/or with variations permutations and combinations of the various features and elements described herein.

Due to the sheer volume of content available over the Internet, an important function that any social networking service provides is to help its members filter through this content to discover and access the content that is most relevant and useful to them. One such type of content is educational courses provided over the Internet by both traditional educational entities (e.g., universities and colleges) and non-traditional entities (e.g., educational websites, subscription services, and MOOC's).

Furthermore, a social networking system can be even more effective if it personalizes the educational courses it suggests to each particular member based on current skill set, opportunities, and career goals. In this way, a social networking system can provide recommendations to a member to help that member move their career forward most efficiently.

In some implementations, a social networking system stores a member profile for each member of the social networking system. These member profiles include all the information that the social networking server system stores for a particular member, including, but not limited to: member name, gender, age, location, contact information, social connections, education, work history, and skills (both implicit and explicit). In some implementations, at least some of the information stored in the member profile is only for internal system calculation and never displayed to any member (e.g., implicit skills). Some information stored in the member profile is displayed in the public profile and still more is shown to the member.

In some implementations, a social networking system further has access to metadata concerning one or more educational courses that are available either in person or online. This metadata includes course names, instructors, the source education institution (e.g., the university or website that produced it), when the course is available, any member restriction (e.g., only subscribers or currently enrolled students can access a particular course), prerequisites, costs, and the skills that are learned by taking the course. In some implementations, this metadata (including skill data) is entirely provided by the educational institution that provides the course. In other implementations the metadata is determined by the social networking server system by analyzing information about the course (e.g., course description). For example, the system may use a naïve Bayes classifier to process course information and determine associated skills. In yet other implementations, metadata is obtained from both sources.

In some implementations, the social network determines, for each member, one or more suggested skills that the social networking server system has determined will be useful for the member to learn. Suggested skills can be any skill a member may want to learn. In some cases, a member's employer can suggest specific educational courses through the social network. In other cases, the social network analyzes a member's current skill set, education, work history, and occupation to identify one or more skills that would be useful for the member to learn. In other cases, the member can choose a desired occupation, and the social networking server system can suggest courses to acquire the skills for the desired occupation. For example, the social networking server system stores a list of skills associated with each occupation. Then the social networking server system can then use the list of skills associated with an occupation to determine skills that the first member lacks. Similarly, the social networking server system can use a combination of data stored in the member profile to identify skills and courses of potential interest to the first member. These skills can then be ranked by importance (e.g., based on earnings data, for example, of members that have each skill) and the social networking server system can select one or more of the most highly ranked skills.

In some implementations, the social networking server system maintains an overall member rating for each member that represents the member's reputation within their field and the social networking system generally. In some implementations the member rating is a reputation score for members of the social networking server system. This member rating can be an objective score, calculated for each member of the system. In other implementations, the member rating is a relative score for ranking members against each other.

In some implementations, the social networking system groups members by the skills they have. For a specific first member, the system can identify one or more similar members (based on having similar skills sets). The system can also specifically select similar members with higher skill ratings than the first member in one or more of the skills that the similar members share with the first member. For example, if the first member has three skills (Hadoop, python, and NoSQL) and a skill rating of 55 in each, the system identifies other members of the system that have one or more of the three skills and a higher skill rating. Then, the social networking system can determine one or more “missing skills” wherein missing skills are skills that are common among members with a higher skill rating than the first member and that the first member does not have (or that the first member has a very low skill rating for).

In some implementations the social networking system then matches the one or more missing skills against the list of skills associated with educational courses to determine one or more courses that provide the one or more missing skills. The social network system can then send the first member a recommendation to enroll in one or more of the courses that provide a skill that the first member lacks.

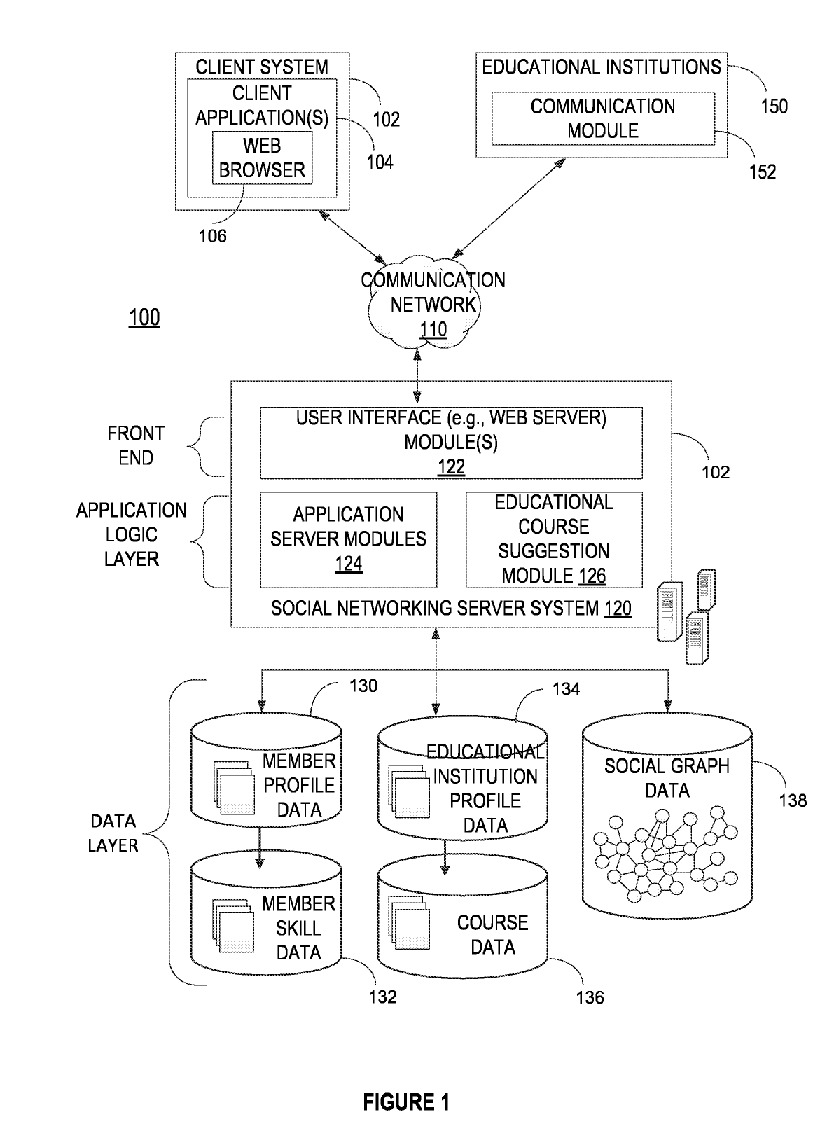

FIG. 1 is a network diagram depicting a client-server system 100 that includes various functional components of a social networking server system 120 in accordance with some implementations. The client-server system 100 includes one or more client systems 102, a social networking server system 120, and one or more educational institutions 150 (e.g., educational course providers). One or more communication networks 110 interconnect these components. The communication network 110 may be any of a variety of network types, including local area networks (LAN), wide area networks (WAN), wireless networks, wired networks, the Internet, personal area networks (PAN) or a combination of such networks.

In some implementations, a client system 102 is an electronic device, such as a personal computer, a laptop, a smartphone, a tablet, a mobile phone or any other electronic device capable of communicating with the network 110. The client system 102 includes one or more client applications 104, which are executed by the client system 102. In some implementations, the client application(s) 104 includes one or more applications from the set consisting of search applications, communication applications, productivity applications, game applications, word processing applications, or any other useful applications. The client application(s) 104 include a web browser 106. The client system 102 uses the web browser 106 to communicate with the social networking server system 120 and displays information received from the social networking server system 120. In some implementations the client system 102 includes an application specifically customized for communication with the social networking server system 120 (e.g., a LinkedIn iPhone application).

In some implementations, the client system 102 sends a request to the social networking server system 120 for a webpage associated with the social networking server system 120 (e.g., the client system 102 sends a request to the social networking server system 120 for an updated member event list). For example, a member of the client system 102 logs onto the social networking server system 120 and clicks to view updates to their personalized event list. In response, the client system 102 receives the updated event list (e.g., news items, recommendations, friend status updates) and displays them on the client system 102.

In some implementations, as shown in FIG. 1, the social networking server system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various implementations have been omitted from FIG. 1. However, a skilled artisan will readily recognize that various additional functional modules and engines may be used with a social networking server system 120, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the various implementations are by no means limited to this architecture.

As shown in FIG. 1, the front end consists of a user interface module (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications, or applications that have been developed for a specific platform to include any of a wide variety of mobile devices and operating systems.

As shown in FIG. 1, the data layer includes several databases, including databases for storing data for various entities of the social graph, including member profile data 130, members skill data 132 (e.g., data describing the skills that each members has), educational institution profile data 134, and course data 136 (e.g., data concerning courses provided by one or more educational institutions 150). In some implementations, the graph data structure is implemented with a social graph database 138, which is a particular type of database that uses graph structures with nodes, edges, and properties to represent and store data. Of course, with various alternative implementations, any number of other entities might be included in the social graph (e.g., companies, organizations, schools and universities, religious groups, and any other group), and as such, various other databases may be used to store data corresponding with other entities.

Consistent with some implementations, when a person initially registers to become a member of the social network service implemented by the social networking server system 120, the person will be prompted to provide some personal information, such as his or her name, age (e.g., birth date), gender, interests, contact information, home town, address, educational background (e.g., schools, majors, etc.), current job title, job description, industry, employment history, skills, professional organizations, and so on. This information is stored, for example, in the member profile database with reference number 130.

In some implementations the member profile database 130 includes member skill data 132. In other implementations the member skill data 132 is distinct from, but associated with, the member profile database 130. The member skill data 132 stores, in a database, skill data for each member of the social networking server system 120. Skills stored in the member skill data 132 include both explicit skills and implicit skills.

In some implementations, explicit skills are skills that the member is determined to have based on skill information directly received from the member. For example, a member reports that they have skills in C++, Java, PHP, CSS, and Python. Because the member directly reported these skills, they are considered explicit skills. In some implementations, explicit skills are listed on a member's public profile.

In some implementations, one or more skills are determined based on an analysis of the non-skill data stored in a member profile. Skills determined in this way are considered implicit skills. Implicit skills are determined or inferred by analysing data stored in a member profile, including but not limited to: education, job history, hobbies, friends, skill ratings, interests, projects a member has worked on, activity on the social networking server system (FIG. 1, 120), and member submitted comments. In some implementations, implicit skills may also be called inferred skills or skills a member may have. For example, member A lists an undergraduate degree in architecture and has a past job history that includes Project Architect for at least three different projects. The system 120 determines that member A has the skill “AutoCAD” even though the member has not directly reported having that skill. In some implementations, implicit skills are not listed on a member's public profile.

In some implementations, both explicit and implicit skills have an associated confidence level. A confidence level associated with a skill reflects the system 120's confidence that the member actually has the listed skill. In the above example, the social networking server system 120 gives member A's skill in AutoCAD a high confidence score based on Member A's listed profile data even though the skill is an implicit skill. Similarly, if a member lists chemical engineering as a skill but does not have any educational or work experiences on their profile related to chemical engineering, the social networking server system 120 gives the skill a low confidence level. In some implementations, confidence levels are represented as a value between 0 and 1, with 1 indicated the highest possible confidence and 0 indicating the lowest possible confidence. In other implementations skill levels are represented as one of several discreet values (e.g., “Very Low Confidence”, “Low Confidence”, “Average Confidence,” “High Confidence,” and “Very High Confidence.”)

In addition, each skill has an associated skill level. The associated skill level represents the system 120's best estimation of a respective member's mastery of a particular skill. In some implementations, a skill level is determined based on an analysis of a member's education and work history. For example, an architect with 10 years of experience will have a higher AutoCAD skill level than a recently graduated architect. In some implementations, recommendations and reviews from other members in the social networking server system 120 are used to estimate a member's skill level. For example, if Member A has 10 positive reviews and recommendations for their patent drafting skill and Member B has only one, the social networking server system 120 will assign Member A a higher skill level rating in patent drafting and Member B a lower one.

Once registered, a member may invite other members, or be invited by other members, to connect via the social network service. A “connection” may call for a bi-lateral agreement by the members, such that both members acknowledge the establishment of the connection. Similarly, with some implementations, a member may elect to “follow” another member. In contrast to establishing a “connection”, the concept of “following” another member typically is a unilateral operation, and at least with some implementations, does not require acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph data 138.

The social network service may provide a broad range of other applications and services that allow members the opportunity to share and receive information, often customized to the interests of the member. For example, with some implementations, the social network service may include a photo sharing application that allows members to upload and share photos with other members. As such, at least with some implementations, a photograph may be a property or entity included within a social graph. With some implementations, members of a social network service may be able to self-organize into groups, or interest groups, around a subject matter or topic of interest. In some implementations, the data for a group may be stored in database. When a member joins a group, his or her membership in the group will be reflected in the social graph data 138.

With some implementations, members may subscribe to or join groups affiliated with one or more companies. For instance, with some implementations, members of the social network service may indicate an affiliation with a company at which they are employed, such that news and events pertaining to the company are automatically communicated to the members. With some implementations, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data 138.

In some implementations, the educational institution profile data 134 includes profiles for a plurality of educational institutions 150. The educational institution profile data 134 includes profiles for traditional educational institutions (e.g., universities, colleges, community colleges, etc.) and new types of educational institutions (Massively Open Online Courses (MOOCs) like Coursera, for-profit online courses such as Lynda.com, and others). Each educational institution profile lists courses offered by the educational institution 150, where students can access the courses (e.g., whether its courses are offered at a physical location like a campus or online), what students are eligible to take the courses (e.g., some educational institutions are free and open to anyone, while others require a fee or prerequisites), contact information, and any other information related to the educational institution 150.

In some implementations, the course data 136 includes information on all the courses offered by the educational institutions listed in the educational institution profile data 134. Each course contained in the course data 136 has one or more associated skills. The one or more associated skills represent the skills a member can expect to acquire by completing the course. Each course also has associated information concerning which educational institution 150 offers the courses, who can take the course, the teacher of the course, the cost associated with the course, prerequisites, any required materials (e.g., textbooks or supplies), and a quality or reputation rating. For example, the course “Intro to Java Programming” lists that it is offered by Lynda.com, is available online to subscribers to Lynda.com, has no prerequisites, and does not have any additional required materials.

In some implementations, the application logic layer includes various application server modules 124, which, in conjunction with the user interface module(s) 122, generate various member interfaces (e.g., web pages) with data retrieved from various data sources in the data layer. With some implementations, individual application server modules 124 are used to implement the functionality associated with various applications, services and features of the social network service. For instance, a messaging application, such as an email application, an instant messaging application, or some hybrid or variation of the two, may be implemented with one or more application server module 124. Similarly, a search engine enabling members to search for and browse member profiles may be implemented with one or more application server module 124. Of course, other applications or services that utilize the educational course suggestion module 126 may be separately implemented in their own application server modules 124.

In addition to the various application server modules 124, the application logic layer includes the educational course suggestion module 126. As illustrated in FIG. 1, with some implementations the educational course suggestion module 126 is implemented as a service that operates in conjunction with various application server modules 124. For instance, any number of individual application server modules 124 can invoke the functionality of the educational course suggestion module 126 to include an application server module 124 associated with applications for identifying appropriate educational courses. However, with various alternative implementations, the educational course suggestion module 126 may be implemented as its own application server module such that it operates as a stand-alone application. With some implementations, the educational course suggestion module 126 includes or has an associated publicly available application programming interface (API) that enables third-party applications to invoke the functionality of the educational course suggestion module 126.

Generally, the educational course suggestion module 126 identifies one or more educational courses appropriate for a specific member and sends the member one or more recommendations. The educational course suggestion module 126 does so by determining one or more suggested skills for a respective member. Suggested skills are identified based on the skills (both implicit and explicit) already associated with the member. In some implementations, the social networking server system 120 selects an implicit skill listed in a member's profile as a suggested skill. If an implicit skill is selected as a suggested skill, the member can then improve the skill and/or explicitly confirm that they have the skill.

In some implementations, the educational course suggestion module 126 determines suggested skills for a first member by identifying one or more members of the social networking server system 120 who have a similar skill set to the first member but have higher skill ratings than the first member. The educational course suggestion module 126 then compares the first member skill set and the skill set of one or more identified members to determine the specific ways in which the first member's skill set is deficient (e.g., which important skills are missing and what important skills have a skill rating that is too low). In some implementations, the educational course suggestion module 126 determines that the other members' skill sets all include a particular skill or group of skills that the first member's skill set is lacking. For example. Member A's s member profile includes skill B with skill rating 10, skill C with skill rating 35, and skill D with skill rating of 23. The system 120 identifies Member X, Member Y, and Member Z as all having skills B, C, and D and skill ratings above those of Member A. The system 120 determines that Members X, Y, and Z all have skill D while member A does not. As a result, the system 120 determines that Member A is missing skill D.

In some implementations, the educational course suggestion module 126 runs all the matching, ranking, and recommendation-generating computations on a system that is not connected, or at least not directly connected, to the communication network 110. Thus the processor-intensive calculations are performed on dedicated, off-line hardware and then forwarded to the social networking server system 120. In some implementations, the data is sent as a key-value pair, wherein the key is a member ID value and the value is a list of recommended courses.

In some implementations, once the educational course suggestion module 126 determines one or more skills that a member is missing, the educational course suggestion module 126 identifies one or more educational courses that are associated with the missing skills. In some implementations, the educational course suggestion module 126 ranks the one or more identified education courses. In some implementations, the courses are ranked by one or more factors including, but not limited to, popularity, ease of access, cost, course rating, the degree to which the course matches the skills needed by a member, etc.

In some implementations, the educational course suggestion module 126 selects one or more courses for the member. In some implementations, the courses are selected based on the course rankings. The educational course suggestion module 126 then transmits recommendations to the member for the selected one or more courses.

In some implementations, one or more educational institutions 150 (e.g., colleges, universities, online education providers) are connected to the communication network 110. The social networking server system 120 can communication with the educational institutions 150 via the communication module 152 to get updated course information and to provide members with links to the recommended courses.

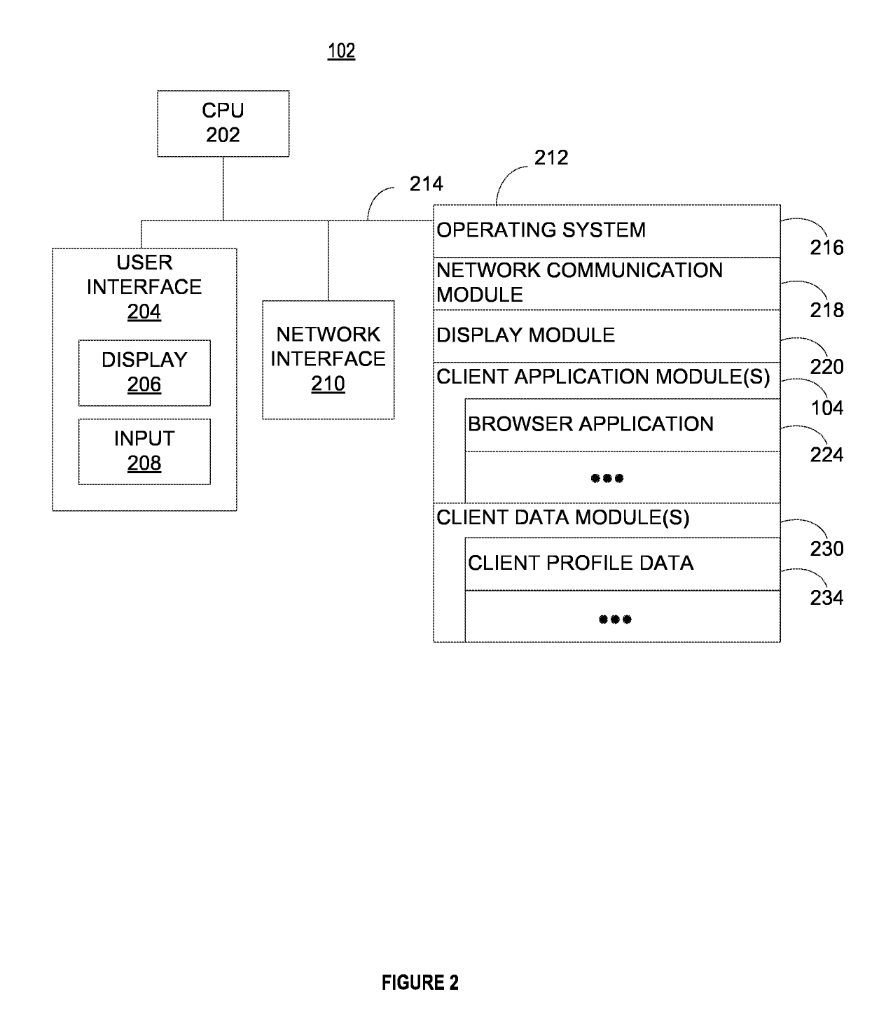

FIG. 2 is a block diagram illustrating a client system 102 in accordance with some implementations. The client system 102 typically includes one or more processing units (CPUs) 202, one or more network interfaces 210, memory 212, and one or more communication buses 214 for interconnecting these components. The client system 102 includes a user interface 204. The user interface 204 includes a display 206 and optionally includes an input means such as a keyboard, mouse, a touch sensitive display, or other input buttons 208. Furthermore, some client systems use a microphone and voice recognition to supplement or replace the keyboard.

Memory 212 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, comprises a non-transitory computer readable storage medium.

In some implementations, memory 212 or the computer readable storage medium of memory 212 stores the following programs, modules and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks (e.g., communication network of FIG. 1), such as the Internet, other wide area networks, local area networks, metropolitan area networks, etc.;
a display module 220 for enabling the information generated by the operating system 216 and client applications 104 to be presented visually on the display 206;
one or more client applications 104 for handling various aspects of interacting with the server system (FIG. 1, 120), including but not limited to:
   a browser application 224 for requesting information from the server system 120 (e.g., product pages and member information) and receiving responses from the social networking server system 120; and
client data module(s) 230, for storing data relevant to the clients, including but not limited to:
   client profile data 234. for storing profile data related to a member of the social networking server system 120 associated with the client system 102.

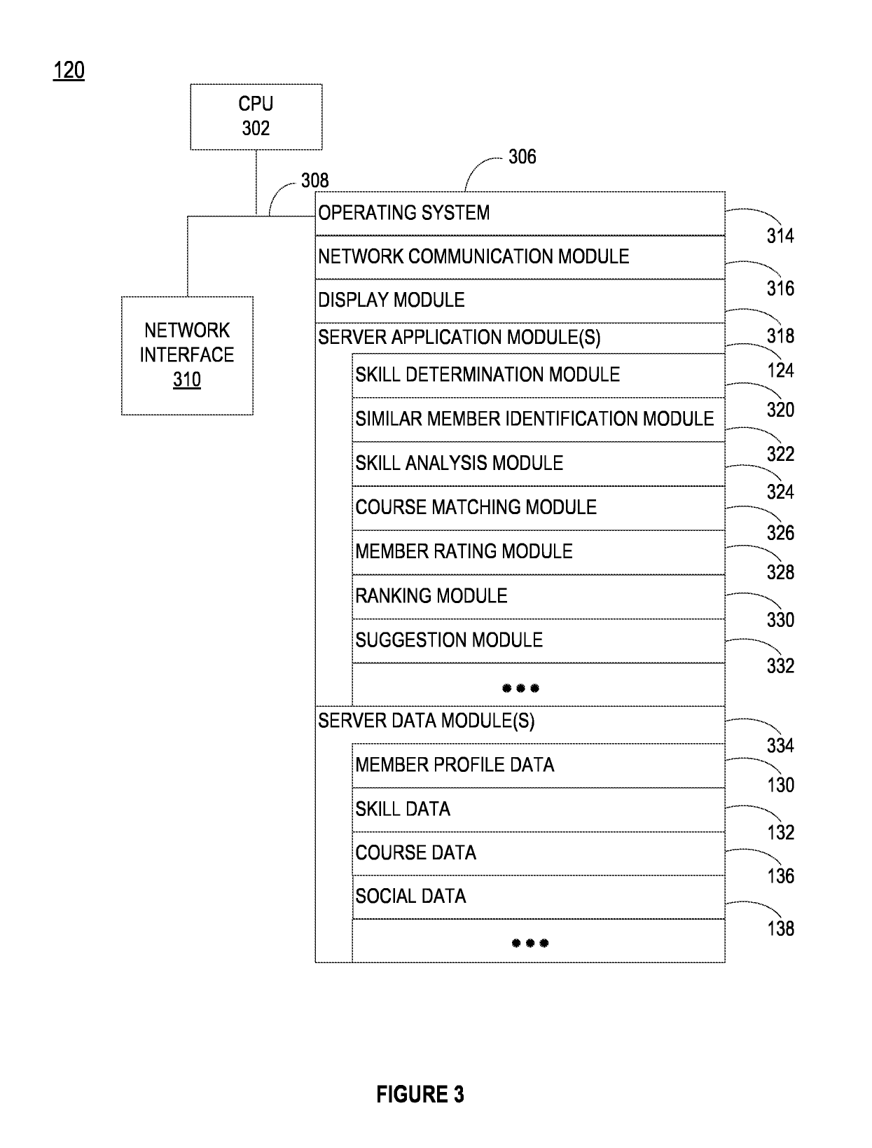

FIG. 3 is a block diagram illustrating a social networking server system (e.g., system 120 of FIG. 1) in accordance with some implementations. The social networking server system 120 typically includes one or more processing units (CPUs) 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some implementations, memory 306 or the computer readable storage medium of memory 306 stores the following programs, modules and data structures, or a subset thereof:
an operating system 314 that includes procedures for handling various basic system services and for performing hardware dependent tasks;
a network communication module 316 that is used for connecting the server system 120 to other computers via the one or more communication network interfaces 310 (wired or wireless) and one or more communication networks, such as the Internet, other wide area networks, local area networks, metropolitan area networks, and so on;
one or more server application modules 124 for performing the services offered by social networking server system 120, including but not limited to:
   a skill determination module 320 for determining skills associated with specific members either based on information received directly from a member (explicit skill) or by analysing other data in the use profile (implicit skill);
   a similar member identification module 322 for identifying members that have the same or substantially similar skill sets;
   a skill analysis module 324 for determining if a specific member is missing important skills based on an analysis of similar members;
   a course matching module 326 for using a given skill to select one or more courses that provide the given skill;
   a member rating module 328 for generating an overall member rating for a member based on the member's work history, education, social graph, recommendations, and review;
   a ranking module 330 for sorting a plurality of skills or courses from most important to least important based on metadata for the plurality of skills or courses; and
   a suggestion module 332 for recommending educational courses to member of the social networking server system 120;
server data module(s) 334, holding data related to social networking server system (FIG. 1, 120), including but not limited to:
   member profile data 130 including member's name, age (e.g., birth date), gender, interests, contact information, home town, address, educational background (e.g., schools, majors, etc.), current job title, job description, industry, employment history, skills, professional organizations, and so on;
   member skill data 132 including skill information for each member, skill ratings, and a confidence score for each skill, wherein skill ratings represent the degree to which a member is proficient with a particular skill, and a confidence score represents the certainty that the member actually has the particular skill;
   course data 136 including data for each course potentially recommended by the social networking server system 120 such as course date, time, availability, credit amount, whether a certificate is offered, location, prerequisites, etc.; and
   social graph data 138 including data that represents members of the server system 120 and the social connections between them.

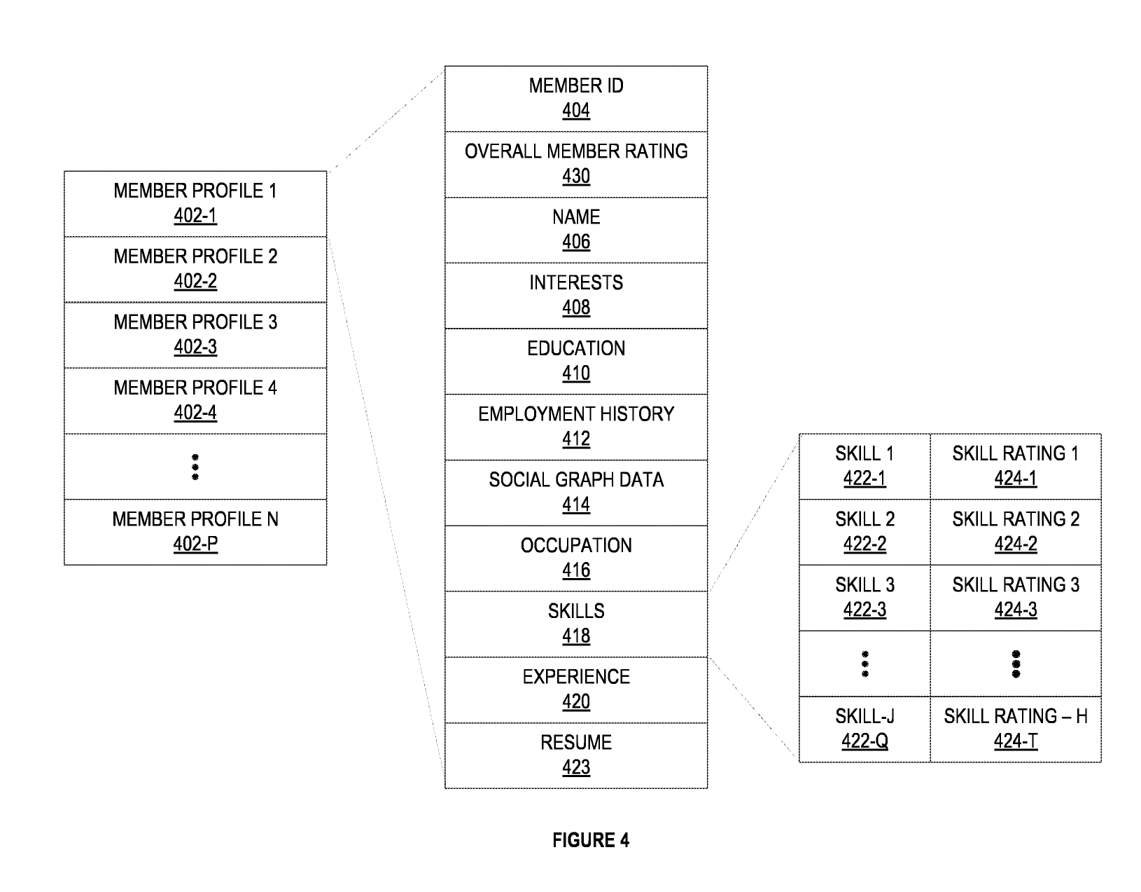

FIG. 4 depicts a block diagram of an exemplary data structure for the member profile data 130 for storing member profiles in accordance with some implementations. In accordance with some implementations, the member profile data 130 includes a plurality of member profiles 402-1 to 402-P, each of which corresponds to a member of the social networking server system (FIG. 1, 120).

In some implementations, a respective member profile 402 stores a unique member ID 404 for the member profile 402, the overall member rating for the member, a name 406 for the member (e.g., the member's legal name), member interests 408, member education history 410 (e.g., the high school and universities the member attended and the subjects studied), employment history 412 (e.g., member's past and present work history with job titles), social graph data 414 (e.g., a listing of the member's relationships as tracked by the social network server system (FIG. 1, 120)), occupation 416, skills 418, experience 420 (for listing experiences that don't fit under other categories like community service or serving on the board of a professional organization), and a detailed member resume 423.

In some implementations, a member profile 402 includes a list of skills (422-1 to 422-Q) and associated skill ratings (424-1 to 424-T). Each skill 422 represents a skill or ability that the member associated with the member profile 402 has. For example, a computer programmer might list FORTRAN as a skill. In addition, each skill has an associated skill rating 424. In some implementations, a skill rating represents the social networking server system's (FIG. 1, 120) estimation of the member's proficiency in a skill. For example, the skill rating could be a number from 1 to 100 wherein 100 is the highest skill and 1 is the lowest. Thus a member who had AutoCAD with a skill rating of 25 would be less proficient using AutoCAD than a member with a skill rating of 78. In some implementations an overall member rating is generated based on feedback from other members (e.g., recommendations or endorsements) and based on the information stored in the member profile 402 associated with the member.

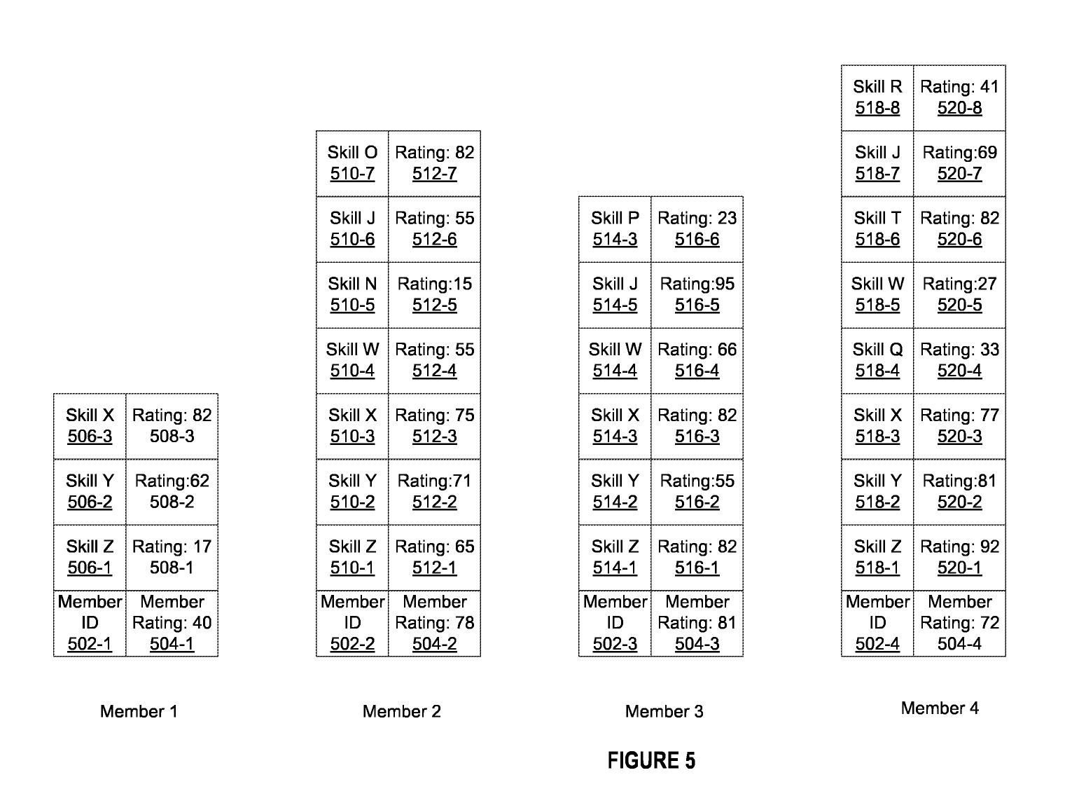

FIG. 5 depicts a block diagram of an exemplary skill set data structure for a plurality of members of the social networking server system (FIG. 1, 120). Each skill set includes a member ID (502-1 to 502-4), an overall member rating (504-1 to 504-4), and one or more skills associated with the member. The member ID (502) represents a unique value that identifies a specific member of the social networking server system (FIG. 1, 120). For example, a user name or an assigned number in a database can serve this purpose. The member rating (504) is a score that represents a member's reputation or estimated ability. The member rating is generated based on one or more of a member's education, a member's work history, a member's connection in the social graph, ratings and responses from other members, and any other information stored in the member profile.

Each skill has a skill unique skill ID (506, 510, 514, and 518) and each skill has an associated rating (508, 512, 516, 520). A skill rating represents a member's competency in the respective skill. For example, the skill rating is a number between 1 and 100, wherein 100 represents a high level of competency and 1 represents the lowest possible level of competency.

In FIG. 5, four member profiles are displayed. In this example, the social networking server system (FIG. 1, 120) is attempting to determine one or more suggested skills for Member 1. First, the social networking server system (FIG. 1, 120) determines Member 1's current skill set (in this case Skill Z, Skill, Y, and Skill X). The social networking server system (FIG. 1, 120) then identifies one or more others members in the system that have a similar skill set but with higher skill ratings than Member 1. In some implementations, these other member profiles are referred to as target member profiles. In this way the social networking server system (FIG. 1, 120) can suggest skills that have some likelihood of increasing a member's skill set in a useful way. The social networking server system (FIG. 1, 120) identifies Member 2, Member 3, and Member 4, all of whom have Skills Z, Y, and X and also higher skill ratings than Member 1.

In some implementations, one or more target member profiles are identified based solely on the skill scores, without using an overall member rating. The social networking server system (FIG. 1, 120) identifies one or more target member profiles that have the skills present in Member 1's profile but have a higher skill rating for each skill. Thus, the social networking server system (FIG. 1, 120) does not consider the overall member rating and only finds target profiles with high skill ratings in the skills included in the first member profile.

The social networking server system (FIG. 1, 120) then determines one or more skills in which Member 1 is deficient. This can be accomplished in one or more ways. The social networking server system (FIG. 1, 120) first determines whether Member 1 is missing any skills that are common to the identified other target members. In this case, the social networking server system (FIG. 1, 120) determines that Member 1 is missing Skill W and Skill J. Members 2, 3, and 4 all have both skills, and Member 1 has neither. The social networking server system (FIG. 1, 120) also determines whether Member 1 has any skills with a skill rating that is significantly below the standard set by the other identified members. In this case, the social networking server system (FIG. 1, 120) determines that skill Z of Member 1 (which has a rating of 17) is significantly lower than the skill rating that Member 2, 3, and 4 have for Skill Z (the ratings are 65, 82, and 72, respectively).

Thus the social networking server system (FIG. 1, 120) identifies Skills W and J as missing from Member 1's skill set and Member 1's Skill Z as a subpar skill. The social networking server system (FIG. 1, 120) can then identify one or more of Skills W, J, and Z as suggested skills for improving Member 1's skill set. The social networking server system (FIG. 1, 120) will use the identified skills to select and recommend one or more courses.

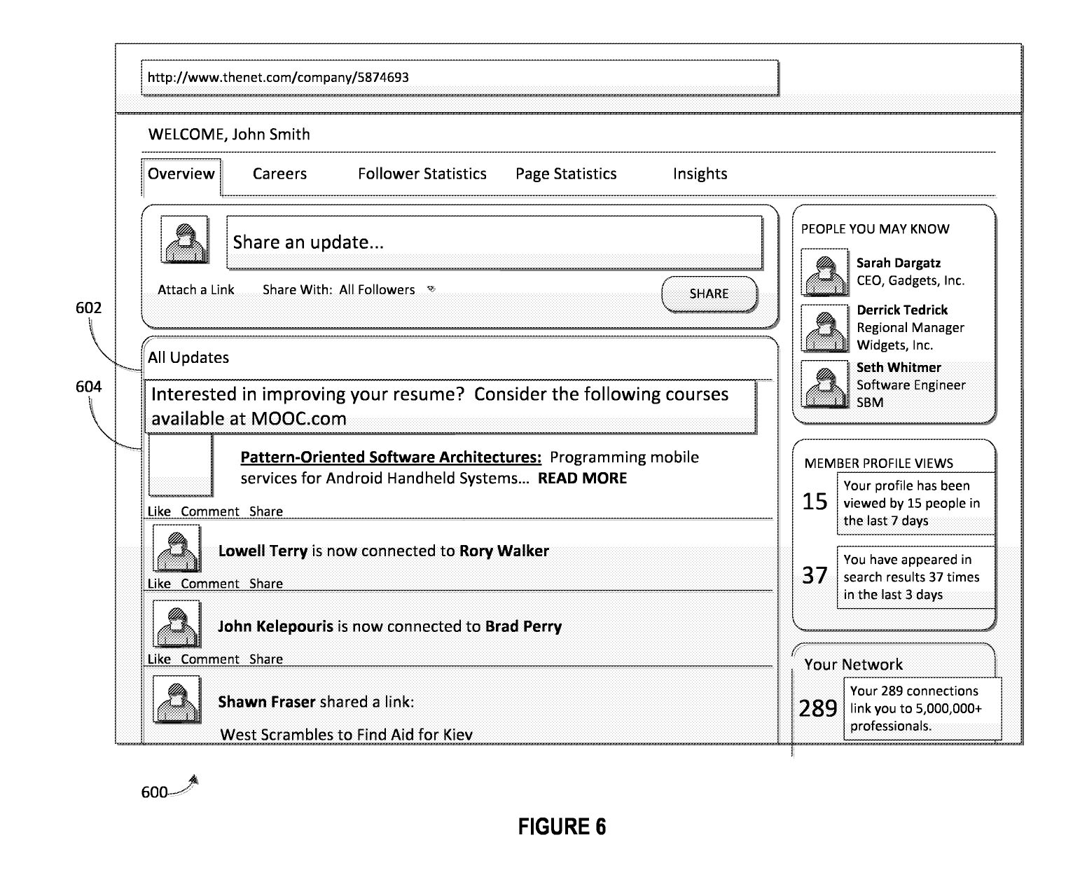

FIG. 6 is a member interface diagram illustrating an example of a member interface 600 or web page having a personalized data feed (or content stream) via which a member of a social network service receives messages, status updates, and recommendations, according to some implementations. In the example member interface of FIG. 6, a content module 602 represents a personalized data feed or content stream for a member of the social network service with the name John Smith. In this example, not only does the content stream present content selected specifically for John Smith, the content stream itself is presented within a member interface or web page that is personalized for John Smith. With some implementations, a personalized data feed or content stream has associated with it various configuration settings that enable the member to specifically filter or select the type of content the member desires to view in the personalized content stream. In this example, the message or status update 604 is included in John Smith's personalized content stream because the social networking server system (FIG. 1, 120) determined that the suggested course (Pattern-Oriented Software Architecture) would usefully increase John Smith's skill set and help further his career.

As shown in FIG. 6, the content module 602 includes buttons or links that enable the viewing member to interact or engage with the recommendation. In particular, a button labelled “like” allows the member to upvote the suggestion or express a favorable opinion of the recommendation and the course it recommends. Similarly, a button labelled “share” allows the viewing member to share the recommendation or status update with another member of the social network service, for example, by re-publishing the recommendation to another member's personal data feed or content stream. Finally, a button labelled “comment” allows the member to comment on the recommendation or status update, for example, by entering some text that will be presented with the recommendation or status update and be visible in the personalized content streams of other members of the social network service.

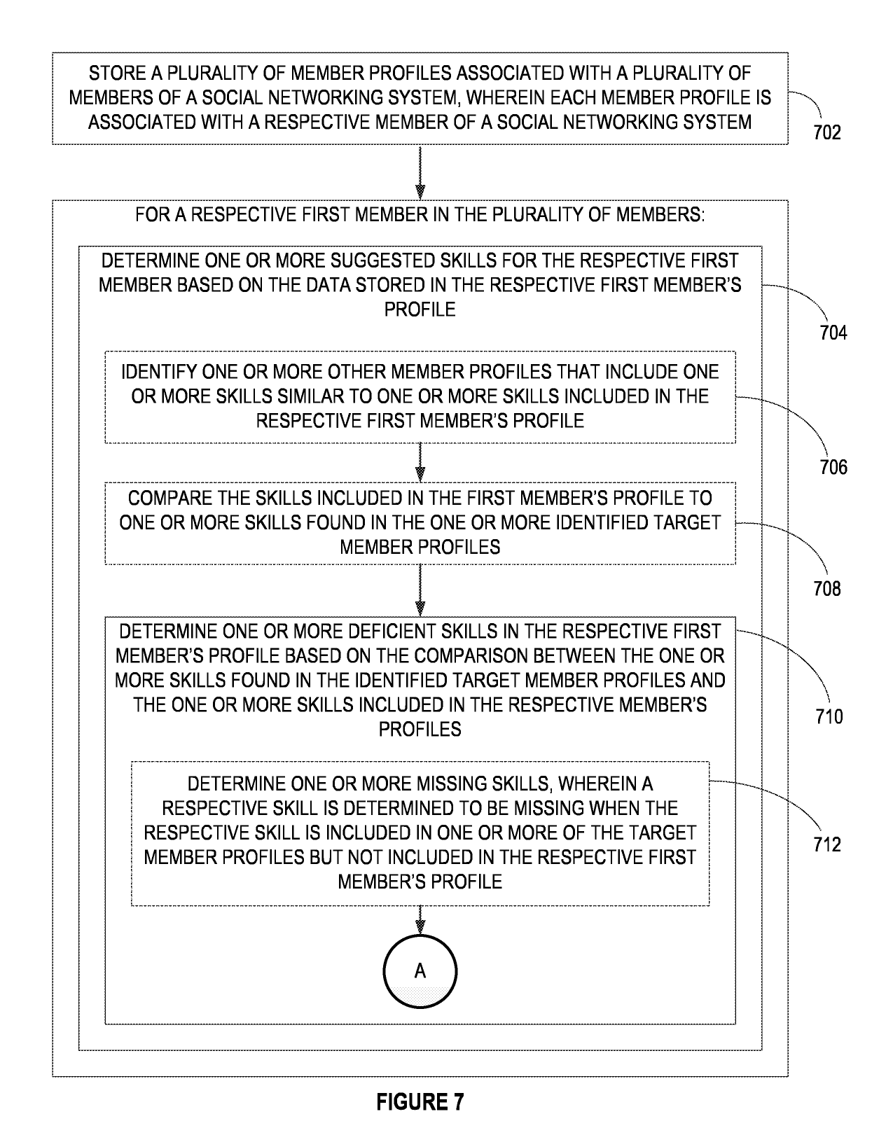

FIG. 7 is a flow diagram illustrating a process for recommending educational courses to members of a social networking server system (e.g., system 120) in accordance with some implementations. Each of the operations shown in FIG. 7 may correspond to instructions stored in a computer memory or computer readable storage medium. Optional operations are indicated by dashed lines (e.g., boxes with dashed-line borders). In some implementations, the method described in FIG. 7 is performed by the social networking server system (FIG. 1, 120).

In some implementations, the method is performed at a social networking system (e.g., system 120 in FIG. 1) including one or more processors and memory storing one or more programs for execution by the one or more processors. The social networking server system (FIG. 1, 120) stores (702) a plurality of member profiles associated with a plurality of members of a social networking system, wherein each member profile includes one or more skills associated with a member of the social networking system. Each member profile is associated with a respective member of a social networking system.

Each member profile also includes, but is not limited to: the member's name, age (e.g., birth date), gender, interests, contact information, home town, address, educational background (e.g., schools, majors, etc.), current job title, job description, industry, employment history, skills, professional organizations, interactions the member has had through the social networking system and so on. In some example embodiments a member profile also stores an overall member rating for the associated member. The overall member rating is used to determine and quantify the status of a member among his or her peers and to represent a member's overall skill and reputation. Members with a large number of highly rated contacts, favorable reviews, and recommendations will have a higher overall member score than a member without those attainments.

In some implementations, each skill included in a member profile has an associated skill rating. The associated skill rating represents the competence level of the member with the skill. Thus, the higher the skill rating, the better the member is at the respective skill. Furthermore, skills in a member profile can be either explicit skills or implicit skills. Explicit skills are skills that that are determined based on skill information directly received from the member (e.g., the member submits a list of skills). In contrast, implicit skills are skills that the social networking server system (FIG. 1, 120) determines a member has based on non-skill information stored in the member profile, such as education, work history, and the member's interaction on the social networking system. In some implementations, each skill in a member profile also includes a confidence level, wherein the confidence level represents the certainty that the member actually has the skill. For example, if the member reports a skill (e.g., an explicit skill) but lacks any education or work history in that area, the system 120 will have low confidence that the member actually has the skill. In some implementations implicit skills generally have lower confidence scores than explicit skills.

In some implementations, each member profile lists a current occupation for the associated member. The social networking server system (FIG. 1, 120) then uses the occupation to help determine one or more suggested skills. For example, Member A lists his or her occupation as “Firefighter.” The social networking server system (FIG. 1, 120) determines that most Firefighters have a high skill level with ladder operation. Member A does not report any skill in ladder operation and the system 120 determines that ladder operation is a suggested skill for Member A, to help bring his or her skill set in line with those common to other firefighters.

The social networking server system (FIG. 1, 120), for a respective first member in the plurality of members, determines (704) one or more suggested skills for the respective first member based on data stored in the respective first member's profile. In some implementations, the data stored in the first respective member's profile includes, but is not limited to, one or more skills, an occupation, a title, work history, educational background, project participation, interests, and previous interactions with the server system 120. To determine one or more suggested skills, the social networking server system (FIG. 1, 120) identifies (706) one or more target members whose member profiles include a list of skills similar to those included in the respective first member's profile (e.g., the list of skills in the identified one or more target member profiles at least partially overlap with the list of skills stored it the member profiles associated with the respective first member). For example, if member A has skills X, Y, and Z, the social networking server system (FIG. 1, 120) then identifies fifteen other member profiles with at least these same skills. In other implementations, the social networking server system (FIG. 1, 120) also identifies other member profiles that have most, if not all, of the skills associated with Member A. In this way, the social networking server system (FIG. 1, 120) is able to identify members with similar skills sets to the skills set of the first member.

The social networking server system (FIG. 1, 120) then selects (708) one or more target member profiles that have higher skill ratings than the respective first member's skill ratings. To do this, the social networking server system (e.g., system 120 in FIG. 1) identifies, for each respective target member profile, the skills the respective target member profile has in common with the first member's profile. The social networking server system (e.g., system 120 in FIG. 1) then determines whether the skill rating that the respective target member profile has for the one or more commons skills is higher that the skill rating for the common skills stored in the first member's profile. In some example embodiments if the respective target member profile has a least one common skill with a higher skill rating than the corresponding skill in the first member's profile the target member profile is selected. In other embodiments a target member profile is only selected if most or all of the common skills in the target member profile have higher skill ratings that the corresponding skill ratings in the first member's profile.

Continuing the example from above, member A has skill ratings of 25, 15, and 60 for skills X, Y, and Z, respectively. Of the 15 identified other member profiles, five have skill ratings below those of member A, five have skill ratings of near or slightly above those of member A, and five have skill ratings significantly higher than those of Member A. In some implementations, the social networking server system (FIG. 1, 120) selects the five identified other member profiles with higher skill ratings than Member A as the target member profiles (e.g., member profiles with skill ratings high enough to serve as a skill goal level). In some implementations, only member profiles with skill ratings that are significantly higher than the first member's skill ratings are selected (e.g., a certain percentage higher like 15% or 20%). In other implementations, all member profiles with skill ratings higher than the first member's skill ratings are selected.

The social networking server system (FIG. 1, 120) compares (710) the skills included in the first member's profile to one or more skills (e.g., common skills that are found both in the target member profile and the first member profile) found in the one or more selected target member profiles. The social networking server system (e.g., system 120 in FIG. 1) the determines one or more deficient skills in the respective first member's profile based on the comparison between the one or more skills found in the identified target member profiles and the one or more skills included in the respective member's profiles.

In some implementations, the social networking server system (FIG. 1, 120) determines (712) one or more missing skills, wherein a missing skill is a skill that is included in one or more of the selected target member profiles but not included in the respective first member's profile. The social networking server system (FIG. 1, 120) analyzes the skills in each of the target member profiles (e.g., profiles of members similar to the first member but who have a higher member skill rating) to identify any skills that are common to the target member profiles but missing from the first member profile. For example, if the first member is a snowboarder, the system 120 may determine that the target member profiles (e.g., snowboarders with better skill ratings than the first member) all include a skill called “Double McTwist 1260.” Because many or all of the target profiles include this skill, but the first member's does not, the system 120 determines that the first member's skill set is deficient because of this missing skill.

In some implementations, the social networking server system (FIG. 1, 120) selects an implicit skill associated with a member as a suggested skill. This allows members to improve existing skills as well as encourages the member to explicitly confirm an implicit skill. Once the member has confirmed, the social networking server system (FIG. 1, 120) has a higher confidence level in the formerly implicit, now explicit skill.

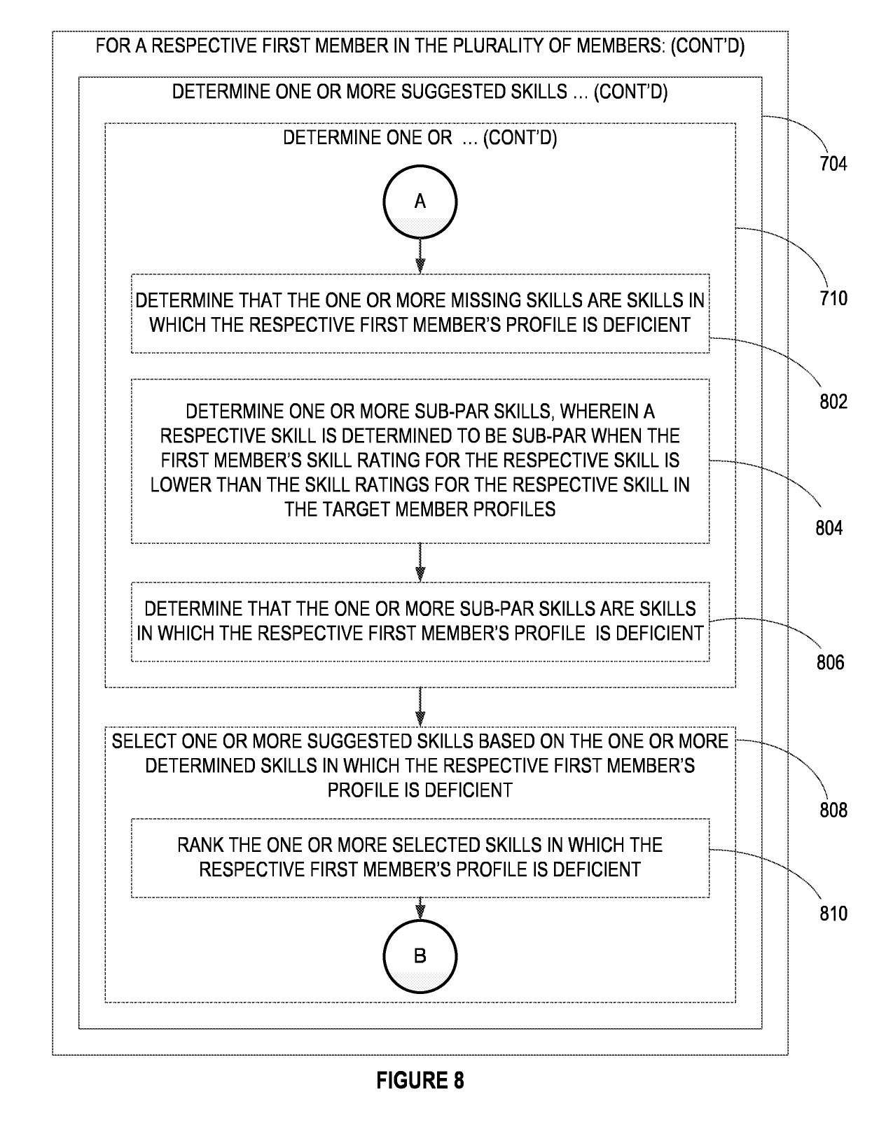

FIG. 8 is a flow diagram illustrating a process for recommending educational courses to members of a social networking server system (e.g., system 120) in accordance with some implementations. Each of the operations shown in FIG. 8 may correspond to instructions stored in a computer memory or computer readable storage medium. Optional operations are indicated by dashed lines (e.g., boxes with dashed-line borders). In some implementations, the method described in FIG. 8 is performed by the social networking server system (FIG. 1, 120).

In some implementations, once one or more missing skills have been identified, the social networking server system (FIG. 1, 120) determines (802) that the one or more missing skills are skills in which the respective first member's profile is deficient. Thus, some of the skills in which the respective first member's profile is deficient are skills that are missing in the first member profile but are found in other similar profiles that are more highly regarded. If the first member associated with the first member profile wants to increase their reputation or desirability in their field, learning a skill that they are missing can help to improve their standing. For example if Member A is a snowboarder who doesn't have the skill “Double McTwist 1260” that many of the highly regarded snowboarders have, Member A can increase his standing and competitiveness by learning the missing skill.

In some implementations, the social networking server system (FIG. 1, 120) determines (804) one or more sub-par skills, wherein a respective skill is determined to be sub-par when the first member's skill rating for the respective skill is lower than the skill ratings for the respective skill in the target member profiles. For example, an architect A has an AutoCAD skill level of 35 and highly rated architects average a skill level of 80 in AutoCAD. Thus, architect A's AutoCAD skills are much worse than the skill level of the highly rated architects, and the system 120 would flag that skill as a subpar skill. The social networking server system (FIG. 1, 120) determines (806) that the one or more subpar skills are skills in which the first respective first member's profile is deficient.

In some implementations, the social networking server system (FIG. 1, 120) determines (808) one or more suggested skills based on the one or more identified skills in which the respective first member's profile is deficient. Thus, the system 120 ranks or filters the one or more skills in which the first member is determined to be deficient to select a smaller number of skills to focus on as suggested skills. This is needed because for any given member, the number of skills in which they are deficient can be very large. The system 120 needs to determine a smaller group of skills to use when generating course suggestions for the member. For example, Member A may have over 50 skills that are either missing from their skills list or subpar. However, 50 is too many skills to generate useful course recommendations for Member A. Thus, the system 120 selects five skills from the group of 50 to focus on.

In some implementations, the system 120 ranks (810) the one or more selected skills in which the respective first member's profile is deficient. In some implementations, skills are ranked from most important (or most vital) to least important. In some implementations, skills are ranked by the number of target member profiles that include the skill. Thus, a skill that is included in the profiles of 90% of target member profiles will rank more highly than a skill that is only present in the profile of 10% of target member profiles. The system 120 can also rank skills that are subpar based on how common the skill is and how far below average the first member's skill rating is. For example, Member A has a skill B with a rating of 40 and skill C with a rating of 10. The average target member skill rating for skill B is 90 and the average target member skill rating for skill C is 18. The system 120 can rank skill B higher because the difference between the first member skill rating (40) and the average target member skill rating for skill B (90) is the greater of the two.

In other implementations, skills are ranked based on a confidence level associated with each identified skill. The associated confidence level reflects the certainty the system 120 has that each identified skill is a skill that the member does not have and would benefit from having. In some implementations, the social network uses data stored in member profiles to establish a confidence level. In some implementations, the more data available related to a particular skill, the higher the confidence level for that recommendation. For example, a member has a highly detailed profile, including in depth descriptions of his or her job and the projects they worked on. The detailed profile information increases the confidence score.

In some implementations, the social networking server system (FIG. 1, 120) uses past member behavior data to determine confidence level. For example, if members with a certain profile attributes (e.g., job titles J1 or J2 or J3, skills S1, S2, S5, or job title J1 for >2 years) tend to click on recommendations for courses about skill Q with high probability, the social networking server system (FIG. 1, 120) will have higher confidence in selecting skill Q. Thus, past member behavior influences the social networking server system (FIG. 1, 120) to select skills for members deemed similar (e.g., profile data that matches or overlaps significantly) based on total “profile distance”. Please note that total distance is a statistical calculation that can be carried out with a variety of statistical techniques. Conversely, if those same members tend to not click on such recommendations, the system 120 will have a lower confidence level for skills related to the recommendation for that particular type of member.

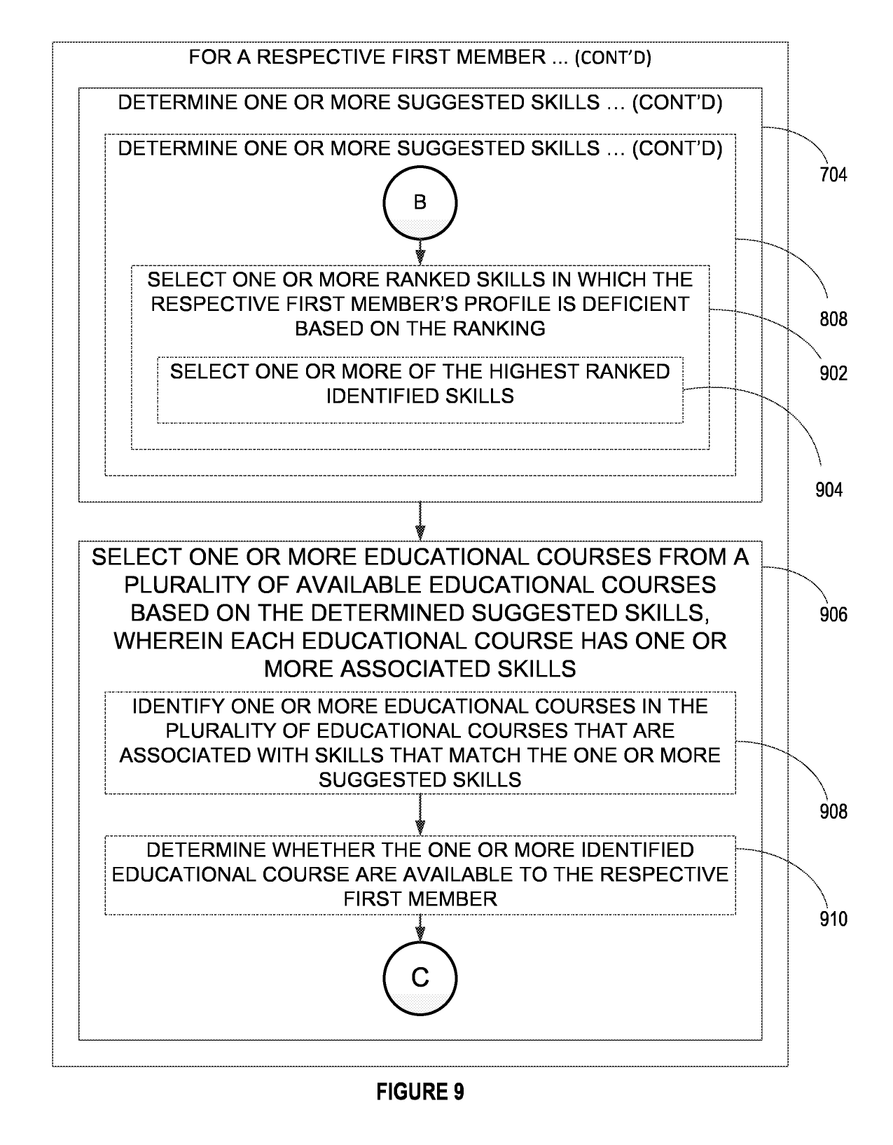

FIG. 9 is a flow diagram illustrating a process for recommending educational courses to members of a social networking server system (e.g., system 120) in accordance with some implementations. Each of the operations shown in FIG. 9 may correspond to instructions stored in a computer memory or computer readable storage medium. Optional operations are indicated by dashed lines (e.g., boxes with dashed-line borders). In some implementations, the method described in FIG. 9 is performed by the social networking server system (FIG. 1, 120).

In some implementations, the social networking server system (FIG. 1, 120) selects (902) one or more ranked skills in which the respective first member's profile is deficient based on the ranking. Thus, the system 120 selects some number of skills from the ranked list of skills. Depending on the specifications of the system 120 and the needs of the first member, the system 120 selects a single skill, a few skills, or multiple skills. For example, the system 120 selects the most important skill based on its ranking, the “Double McTwist 1260,” and only focuses on finding courses to help the first member learn that skill. In some implementations, the social networking server system (FIG. 1, 120) selects (904) one or more of the highest ranked identified skills.

In some implementations the social networking server system (FIG. 1, 120) selects (906) one or more educational courses from a plurality of available educational courses based on the determined useful skills, wherein each educational course has one or more associated skills. In some implementations the educational courses and their associated metadata are stored at the social networking server system (FIG. 1, 120). In other implementations the courses and their metadata are stored at the third party educational providers. The social networking server system (FIG. 1, 120) uses the one or more suggested skills by matching the suggested skills with the stored courses, finding courses that match the suggested skill. In some implementations, more than one course will match a given skill; the social networking server system (FIG. 1, 120) selects one of the matching courses.

In some implementations, each course has an associated rating based on the quality of the material in the course and member feedback ranking the course relative to other courses. Then the system 120 chooses course with the highest ranking. In some implementations the social networking server system (FIG. 1, 120) uses logistic regression (LR), with the above mentioned features, to predict the probability that the member will engage (e.g., accept the recommended course) with this course.

In some implementations, the social networking server system (FIG. 1, 120) identifies (908) one or more educational courses in the plurality of educational courses that are associated with skills that match the one or more suggested skills. The social networking server system (FIG. 1, 120) then determines (910) whether the one or more identified educational course is available to the respective first member. For example, if the educational institution is a university, the social networking server system (FIG. 1, 120) determines whether the first member is close enough to the campus to feasibly attend. If the course is online, the social networking server system (FIG. 1, 120) determines whether the first member has a membership with the site (e.g., a massively open online course provider or a website that requires a membership to access). In some cases a member's employer offers a free membership to an online educational institution and selects specific courses in which its employees should be encouraged to enroll. In some implementations an educational course has pre-requisites and the social networking server system (FIG. 1, 120) only selects a course with pre-requisites if the first member has already met them.

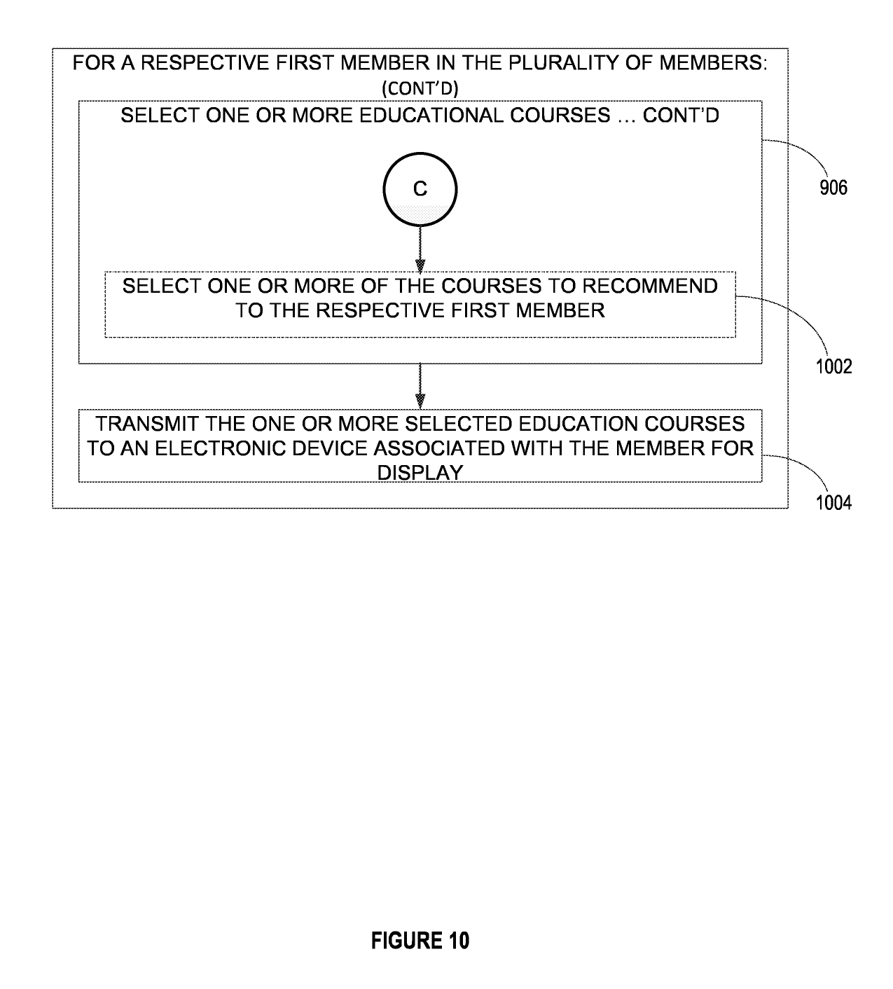

FIG. 10 is a flow diagram illustrating a process for recommending educational courses to members of a social networking server system (e.g., system 120) in accordance with some implementations. Each of the operations shown in FIG. 10 may correspond to instructions stored in a computer memory or computer readable storage medium. Optional operations are indicated by dashed lines (e.g., boxes with dashed-line borders). In some implementations, the method described in FIG. 10 is performed by the social networking server system (FIG. 1, 120).

In some implementations, in accordance with a determination that the one or more identified educational courses are available to the member; the social networking server system (FIG. 1, 120) selects (1002) one or more of the courses to recommend to the respective first member. In some implementations the social networking server system (FIG. 1, 120) transmits (1004) the one or more selected education courses to an electronic device associated with the member for display. In some implementations the recommendation is sent as an email. In other implementations the recommendation is posted on an activity stream in the social networking server system (FIG. 1, 120) web page. In yet other implementations, the social networking server system (FIG. 1, 120) creates a course marketplace page for members to visit that allows members to explore course options and suggest courses; the suggested courses are posted to a personalized course marketplace page for the first member.

The foregoing description, for purpose of explanation, has been described with reference to specific implementations. However, the illustrative discussions above are not intended to be exhaustive or to limit the inventive subject matter to the precise forms disclosed. Many modifications and variations are possible in view of the above teachings. The implementations were chosen and described in order to best explain the principles of the inventive subject matter and its practical applications, to thereby enable others skilled in the art to best utilize the inventive subject matter and various implementations with various modifications as are suited to the particular use contemplated.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

What is claimed is:

1. A method comprising:
storing, at a server system including one or more processors, a plurality of member profiles associated with a plurality of members of a social networking system, wherein each member profile is associated with a respective member of a social networking system and includes one or more skills associated with the respective member; and
for a respective first member in the plurality of members:
determining one or more suggested skills for the respective first member based on data stored in a profile of the respective first member;
selecting one or more educational courses from a plurality of available educational courses based on the determined suggested skills, wherein each educational course has one or more associated skills; and
transmitting the one or more selected educational courses to an electronic device associated with the first member for display.

2. The method of claim 1, wherein the data stored in the first member's profile includes, but is not limited to, one or more skills, an occupation, a title, work history, educational background, project participation, interests, social network and connections, and previous interactions with the social networking system.

3. The method of claim 1, wherein each skill included in a member profile has an associated skill rating.

4. The method of claim 1, wherein one or more skills included in a member profile are determined based on skill information submitted by a member associated with the member profile.

5. The method of claim 1, wherein one or more skills included in a member profile are determined based on an analysis of non-skill data stored in the member profile.

6. The method of claim 1, wherein determining one or more suggested skills further includes:
identifying one or more target member profiles that include one or more skills similar to one or more skills included in the respective first member's profile;
comparing the skills included in the first member's profile to one or more skills found in the one or more identified target member profiles;
determining one or more deficient skills in the respective first member's profile based on the comparison between the one or more skills found in the identified target member profiles and the one or more skills included in the respective member's profiles; and
selecting one or more suggested skills based on the one or more determined skills in which the respective first member's profile is deficient.

7. The method of claim 6, wherein comparing the skills included in the first member's profile to one or more skills found in the one or more identified target member profiles further includes:
determining one or more missing skills, wherein missing skills are skills that are included in one or more of the target member profiles but not included in the respective first member's profile; and
determining that the one or more missing skills are skills in which the first member's profile is deficient.

8. The method of claim 6, wherein comparing the skills included in the first member's profile to one or more skills found in the one or more identified target member profiles further includes:
determining one or more sub-par skills, wherein a respective skill is determined to be sub-par when the first member's skill rating for the respective skill is lower than the skill ratings for the respective skill in the target member profiles; and
determining that the one or more sub-par skills are skills in which the first member's profile is deficient.

9. The method of claim 6, wherein selecting one or more suggested skills based on the one or more identified skills in which the respective first member's profile is deficient includes:
ranking the one or more selected skills in which the respective first member's profile is deficient; and
selecting one or more ranked skills in which the respective first member's profile is deficient based on the ranking.

10. The method of claim 9, wherein selecting one or more ranked skills in which the respective first member's profile is deficient based on the ranking further includes selecting one or more of the highest ranked skills.

11. The method of claim 1, wherein selecting one or more educational courses from the plurality of available educational courses based on the determined suggested skills includes:
identifying one or more educational courses in the plurality of educational courses that are associated with skills that match the one or more suggested skills;
determining whether the one or more identified educational course are available to the respective first member; and
in accordance with a determination that the one or more identified educational courses are available to the member, selecting one or more of the courses to recommend to the respective first member.

12. A system comprising:
one or more processors;
memory; and
one or more programs stored in the memory, the one or more programs comprising instructions for:
storing, at a server system including one or more processors, a plurality of member profiles associated with a plurality of members of a social networking system, wherein each member profile is associated with a respective member of a social networking system and includes one or more skills associated with the respective member; and
for a respective first member in the plurality of members:
determining one or more suggested skills for the respective first member based on data stored in a profile of the respective first member;
selecting one or more educational courses from a plurality of available educational courses based on the determined suggested skills, wherein each educational course has one or more associated skills; and
transmitting the one or more selected educational courses to an electronic device associated with the first member for display.

13. The system of claim 12, wherein the instructions for determining the one or more suggested skills further includes instructions for:
identifying one or more target member profiles that include one or more skills similar to one or more skills included in the respective first member's profile;
comparing the skills included in the first member's profile to one or more skills found in the one or more identified target member profiles;
determining one or more deficient skills in the respective first member's profile based on the comparison between the one or more skills found in the identified target member profiles and the one or more skills included in the respective member's profiles; and
selecting one or more suggested skills based on the one or more determined skills in which the respective first member's profile is deficient.

14. The system of claim 13, wherein the instructions for comparing the skills included in the first member's profile to one or more skills found in the one or more identified target member profiles further include instructions for:
determining one or more missing skills, wherein missing skills are skills that are included in one or more of the target member profiles but not included in the respective first member's profile; and
determining that the one or more missing skills are skills in which the first member's profile is deficient.

15. The system of claim 13, wherein the instructions for comparing the skills included in the first member's profile to one or more skills found in the one or more identified target member profiles further include instructions for:
determining one or more sub-par skills, wherein a respective skill is determined to be sub-par when the first member's skill rating for the respective skill is lower than the skill ratings for the respective skill in the target member profiles; and
determining that the one or more sub-par skills are skills in which the first member's profile is deficient.

16. The system of claim 12, wherein the instructions for selecting one or more educational courses from the plurality of available educational courses based on the determined suggested skills further include instructions for:
identifying one or more educational courses in the plurality of educational courses that are associated with skills that match the one or more suggested skills;
determining whether the one or more identified educational course are available to the respective first member; and
in accordance with a determination that the one or more identified educational courses are available to the member, selecting one or more of the courses to recommend to the respective first member.

17. A non-transitory computer readable storage medium storing one or more programs for execution by one or more processors, the one or more programs comprising instructions for:
storing, at a server system including one or more processors, a plurality of member profiles associated with a plurality of members of a social networking system, wherein each member profile is associated with a respective member of a social networking system and includes one or more skills associated with the respective member; and
for a respective first member in the plurality of members:
determining one or more suggested skills for the respective first member based on data stored in a profile of the respective first member;
selecting one or more educational courses from a plurality of available educational courses based on the determined suggested skills, wherein each educational course has one or more associated skills; and
transmitting the one or more selected educational courses to an electronic device associated with the first member for display.

18. The non-transitory computer readable storage medium of claim 17, wherein the instructions for determining the one or more suggested skills further includes instructions for:
identifying one or more target member profiles that include one or more skills similar to one or more skills included in the respective first member's profile;
comparing the skills included in the first member's profile to one or more skills found in the one or more identified target member profiles;
determining one or more deficient skills in the respective first member's profile based on the comparison between the one or more skills found in the identified target member profiles and the one or more skills included in the respective member's profiles; and
selecting one or more suggested skills based on the one or more determined skills in which the respective first member's profile is deficient.

19. The non-transitory computer readable storage medium of claim 18, wherein the instructions for comparing the skills included in the first member's profile to one or more skills found in the one or more identified target member profiles further include instructions for:
determining one or more missing skills, wherein missing skills are skills that are included in one or more of the target member profiles but not included in the respective first member's profile; and
determining that the one or more missing skills are skills in which the first member's profile is deficient.

20. The non-transitory computer readable storage medium of claim 18, wherein the instructions for comparing the skills included in the first member's profile to one or more skills found in the one or more identified target member profiles further include instructions for:
determining one or more sub-par skills, wherein a respective skill is determined to be sub-par when the first member's skill rating for the respective skill is lower than the skill ratings for the respective skill in the target member profiles; and
determining that the one or more sub-par skills are skills in which the first member's profile is deficient.
